(19) United States
(12) Patent Application Publication
(10) Pub. No.: US 2026/0319907 A1
(43) Pub. Date: Oct. 15, 2026

(54) DEGRADATION-BASED METHOD TO VERIFY PERFORMANCE OF EVALUATION METRICS

(71) Applicant: Oracle International Corporation, Redwood City, CA (US)

(72) Inventors: Naveen Jafer Nizar, Everett, MA (US); Qinlan Shen, Somerville, MA (US)

(21) Appl. No.: 19/563,979

(22) Filed: Mar. 11, 2026

Related U.S. Application Data
(60) Provisional application No. 63/786,845, filed on Apr. 10, 2025.

(51) Int. Cl. G06F 11/34

(52) U.S. Cl. CPC G06F 11/3447

(57) ABSTRACT

Systems, methods, and apparatuses may implement a degradation-based evaluator to verify performance of evaluation metrics. A degradation-based evaluator may iteratively degrade a candidate text to generate a series of candidate texts, then submit the series of candidate text to a target evaluator. The target evaluator may evaluate the series of candidate texts with respect to a reference text to generate a series of performance metrics, then degradation-based evaluator may evaluate the series of performance metrics to verify the performance of the target evaluator.

### PRIORITY CLAIM

This application claims benefit of priority to U.S. Provisional Application Serial No. 63/786,845, titled “Degradation-Based Method to Verify Performance of Evaluation Metrics,” filed Apr. 10, 2025, and which is hereby incorporated herein by reference in its entirety.

### BACKGROUND

The evaluation of long-form text, particularly in domains requiring factual accuracy, is increasingly reliant on automated metrics. However, the reliability of these metrics is often assumed rather than rigorously tested, especially in the context of long-form text. Thus, a gap exists in ensuring the quality of reference-based evaluation metrics.

### SUMMARY

A surge in generative models has led to a proliferation of long-form text generation across various domains. Evaluating the quality of these generated texts is crucial and evaluation metrics play a pivotal role. However, the focus of these metrics has largely been on short-form text evaluation, leaving a significant gap in understanding of how well these metrics perform on long-form text. With the increasing use of Large Language Models (LLMs) like GPT-4 as judges, it becomes imperative to rigorously evaluate the reliability of these evaluation metrics. Systems, methods, and apparatuses are described herein to implement a degradation-based evaluator to verify performance of evaluation metrics. A degradation-based evaluator may iteratively degrade a candidate text to generate a series of candidate texts, then submit the series of candidate text to a target evaluator. The target evaluator may evaluate the series of candidate texts with respect to a reference text to generate a series of performance metrics, then degradation-based evaluator may evaluate the series of performance metrics to verify the performance of the target evaluator.

### BRIEF DESCRIPTION OF THE DRAWINGS

FIG. 1 illustrates a system implementing a degradation-based method to verify performance of evaluation metrics, according to some embodiments.

FIG. 2 illustrates a perturbation mechanism for a degradation-based method to verify performance of evaluation metrics, according to some embodiments.

FIG. 3 illustrates a degradation process for a degradation-based method to verify performance of evaluation metrics, according to some embodiments.

FIG. 4 illustrates a prompt for generating paraphrased versions of texts, according to some embodiments.

FIG. 5 illustrates a prompt for generating a series of atomic facts of texts, according to some embodiments.

FIG. 6 illustrates a prompt for corrupting a one or more facts, according to some embodiments.

FIG. 7 illustrates a prompt for recombining altered facts into a coherent text, according to some embodiments.

FIG. 8 is a flowchart illustrating a degradation-based method to verify performance of evaluation metrics, according to some embodiments.

FIG. 9 is a flowchart illustrating a degradation-based method to select and improve an evaluator, according to some embodiments.

FIG. 10 is a flowchart illustrating a perturbation mechanism for a degradation-based method to verify performance of evaluation metrics, according to some embodiments.

FIG. 11 is a flowchart illustrating selecting and improving performance of a target evaluator using a degradation-based method to verify performance of evaluation metrics, according to some embodiments.

FIG. 12A illustrates variance of metrics for a first candidate perturbation, according to some embodiments.

FIG. 12B illustrates a number of violations for a first candidate perturbation, according to some embodiments.

FIG. 12C illustrates variance of metrics for a second candidate perturbation, according to some embodiments.

FIG. 12D illustrates a number of violations for a second candidate perturbation, according to some embodiments.

FIG. 12E illustrates variance of metrics for a third candidate perturbation, according to some embodiments.

FIG. 12F illustrates a number of violations for a third candidate perturbation, according to some embodiments.

FIG. 12G illustrates variance of metrics for a fourth candidate perturbation, according to some embodiments.

FIG. 12H illustrates a number of violations for a fourth candidate perturbation, according to some embodiments.

FIG. 12J illustrates variance of metrics for a fifth candidate perturbation, according to some embodiments.

FIG. 12K illustrates a number of violations for a fifth candidate perturbation, according to some embodiments.

FIG. 13 illustrates an example computing system, according to some embodiments.

FIG. 14 illustrates an example cloud computing environment whose resources may be employed to implement a topic modeling system that includes stability monitoring, according to at least some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as "configured to" perform a task or tasks. In such contexts, "configured to" is a broad recitation of structure generally meaning "having circuitry that" performs the task or tasks during operation. As such, the unit/circuit/component can be configured to perform the task even when the unit/circuit/component is not currently on. In general, the circuitry that forms the structure corresponding to "configured to" may include hardware circuits. Similarly, various units/circuits/components may be described as performing a task or tasks, for convenience in the description. Such descriptions should be interpreted as including the phrase "configured to." Reciting a unit/circuit/component that is configured to perform one or more tasks is expressly intended not to invoke 35 U.S.C. § 112(f) interpretation for that unit/circuit/component.

This specification includes references to "one embodiment" or "an embodiment." The appearances of the phrases "in one embodiment" or "in an embodiment" do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

A surge in generative models has led to a proliferation of long-form text generation across various domains. Evaluating the quality of these generated texts is crucial and evaluation metrics play a pivotal role. However, the focus of these metrics to date has largely been on short-form text evaluation, leaving a significant gap in understanding of how well these metrics perform on long-form text. With the increasing use of Large Language Models (LLMs) like GPT-4 as judges, it becomes imperative to rigorously evaluate the reliability of these evaluation metrics as these automated judgement techniques may poorly correlate with human judgements.

Automatic evaluation of machine-generated text has long been a central challenge in natural language generation (NLG), often proving as difficult as the generation itself. Driven by the success of large-scale pretrained language models (PLMs), recent research has focused on developing evaluation metrics based on these models. For instance, BERTScore calculates similarity scores between the contextualized embeddings of the generated hypothesis and the reference text. These PLM-based metrics have demonstrated superior correlations with human annotations across various tasks, leading to their increasing adoption in practical applications.

However, it is crucial to acknowledge the inherent limitations of PLMs. These models can produce degenerate, repetitive text and exhibit insensitivity to perturbations such as word order shuffling and negation. These shortcomings, when combined with specific design choices in metric development, can render PLM-based evaluation metrics brittle and susceptible to manipulation. Consequently, careful consideration of these factors is essential for ensuring the reliability and robustness of evaluation methodologies.

Recently, the use of commercial Large Language Models (LLMs) like GPT-4o as "LLM-as-a-judge" evaluators for pairwise comparisons in LLM alignment tasks has become increasingly prevalent. While they have shown a higher agreement to human preference compared to PLM-based methods, they suffer from various shortcomings such as position bias, verbosity bias and self-inclusion bias.

Disclosed herein is a methodology to assess the quality of reference-based evaluation metrics. These metrics compare a generated candidate text against a ground-truth or gold reference. A framework is disclosed that iteratively perturbs candidate texts, allowing evaluation of the sensitivity and discrimination power of various metrics.

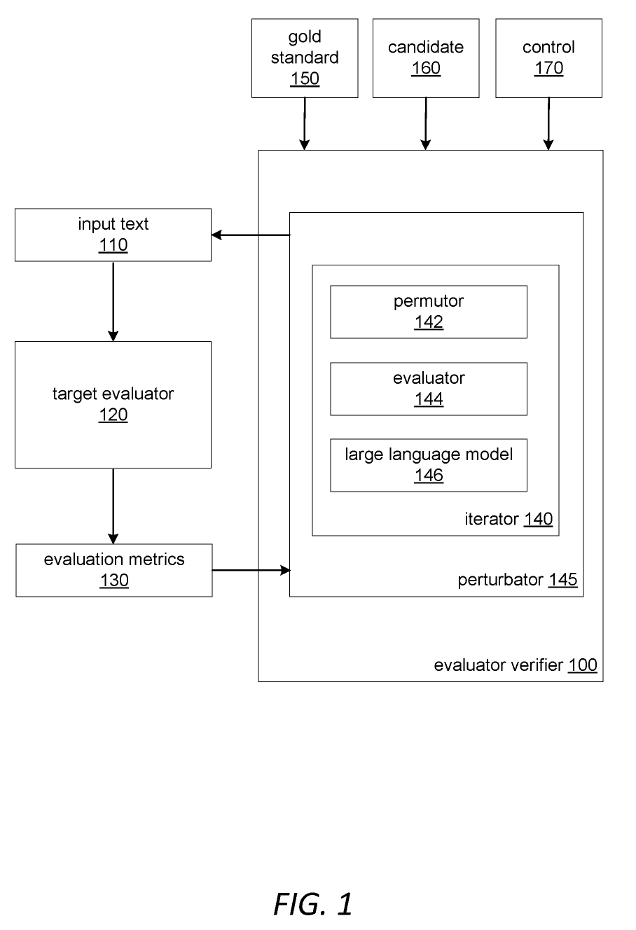

FIG. 1 illustrates a system implementing a degradation-based method to verify performance of evaluation metrics, according to at least one embodiment. In at least one embodiment, a target evaluator 120 to be analyzed may receive input text 110 and perform evaluations to generate evaluation metrics 130. This input text 110 may be iteratively degraded by iterator 140 of perturbator 145 to evaluate the performance of the target evaluator 120. In at least one embodiment, target evaluator 120 may perform evaluations in consideration of criteria 122, where criteria 122 may be adjust or tuned using evaluation results generated by evaluator verifier 100. In at least one embodiment, evaluator verifier 100 may receive a gold standard 150, or ground truth, reference text and a candidate text 160. In at least one embodiment, the evaluator verifier 100 may use an iterator 140 to iteratively perturb candidate text 160 a number of times using permutor 142 that employs a large language model 146, the permuting generating a sequence of degraded candidates C1, C2, ..., Cn provided as input text 110 during various iterations. Each perturbation introduces a controlled level of degradation according to an input control 170, such that the quality of Ci is lower than Ci−1. Perturbations may target various aspects of text quality, including grammatical correctness, brevity, simplicity, factual completeness and factual correctness in various embodiments.

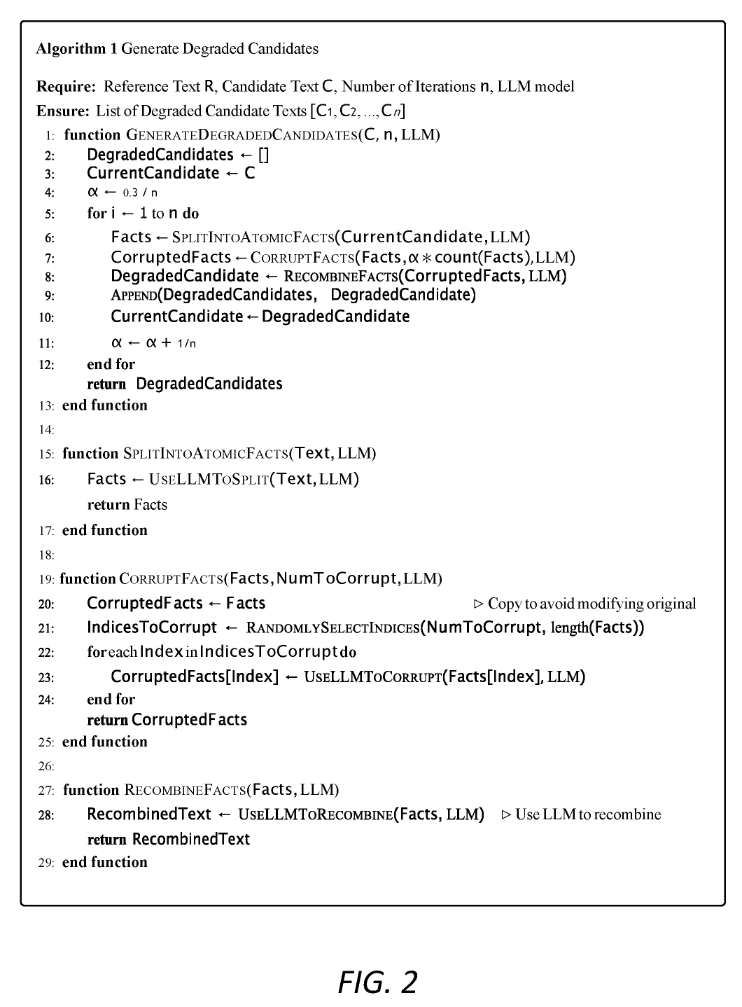

In at least one embodiment, permutor 142 may implement an unsupervised mechanism to perturb factual correctness. An unsupervised mechanism may split a candidate text C into atomic facts, corrupt an increasing percentage of these facts using a large language model 146, such as GPT-4o, and recombine atomic facts, including the corrupted facts, into a coherent long-form text to create the degraded candidates C1, C2, ..., Cn. Algorithm 1, as shown in FIG. 2, illustrates this in detail.

In various embodiments, performance of evaluation metrics 130 may be determined at evaluator 144 by examining two key properties: monotonicity and discrimination power. Regarding monotonicity, a good evaluation metric may assign scores that decrease as the candidate text is increasingly degraded. Mathematically, for an evaluation metric Ei:

Ei(R, C) > Ei(R, C1) > ... > Ei(R, Cn)

Regarding Discrimination Power, a good evaluation metric may discriminate between candidates with differing quality. If two evaluation metrics E1 and E2 are used to score the candidates, E1 is deemed to have higher discrimination power if the differences between its scores are larger than those of E2.

A candidate solution C may be extracted by paraphrasing the gold reference answer R using GPT-4o. The degraded candidates C1, C2, ..., Cn are obtained by the method described in above in FIG. 2. Performance of a metric Ei ∈ E may be evaluated on the pairs:

Ei(R, C), Ei(R, C1), Ei(R, C2), ..., Ei(R, Cn)

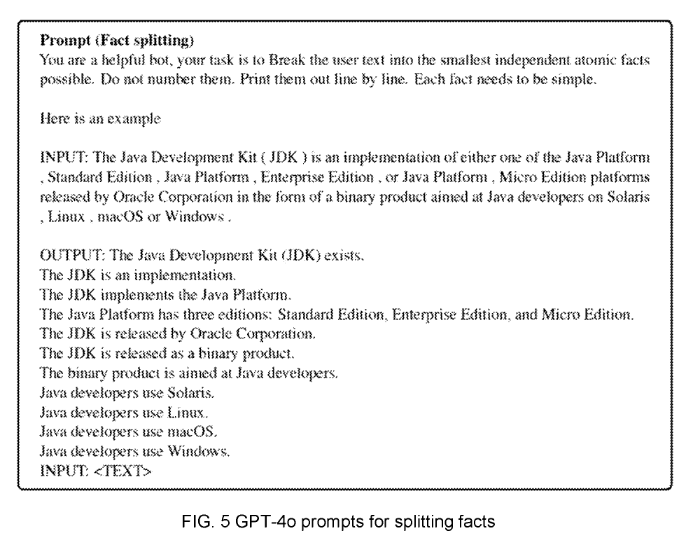

FIG. 2 illustrates a perturbation mechanism for a degradation-based method to verify performance of evaluation metrics, according to some embodiments. In at least one embodiment, a candidate text, C, may be received at a perturbation function defined in lines 1 – 13, the candidate text provided along with a number of degraded candidates, n, and a large language model (LLM), such as LLM 146 of FIG. 1. After initializing local variables in lines 2 – 4, the function performs a number of requested iterations n as shown in lines 5 – 12. In at least one embodiment, local variables may be initialized to ensure a controlled level of degradation such as by using controls such as input control 170 of FIG. 1. An iteration begins but splitting a current candidate text into a set of atomic facts, where the current candidate text is the degraded candidate of an immediately previous iteration or the provided candidate text in the event that the current iteration is a first iteration. Splitting a candidate text into atomic facts may be performed in at least one embodiment by using the specified LLM along with a prompt such as shown in FIG. 5 below.

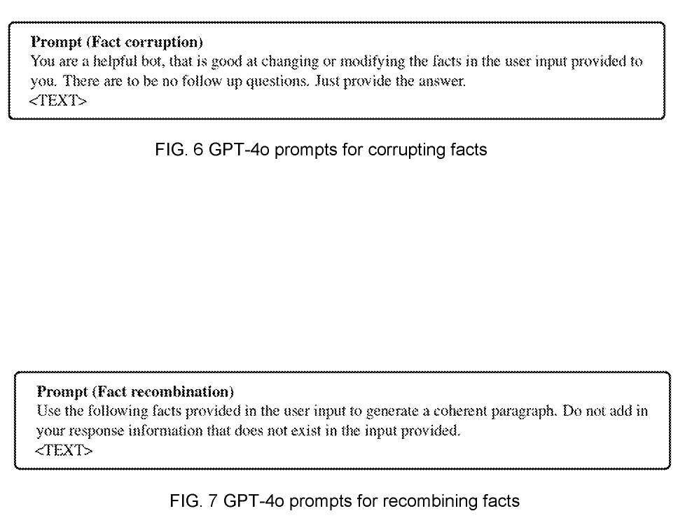

Then, in at least one embodiment, selected facts may be corrupted as shown in line 7 and lines 19 – 25. A number of facts to corrupt may be determined, in at least one embodiment, according to a number of iterations as shown in lines 4, 7 and 11, where individual facts may be selected randomly as shown in line 21. Individual selected facts may be corrupted using the LLM and a prompt such as shown in FIG. 6 below. Then, the degraded facts may be recombined with the candidate text using the LLM and a prompt such as shown in FIG. 7 below. The process may then proceed to a next iteration. Once all iterations have been performed, a set of degraded candidates may be return in at least one embodiment. Although a single LLM is shown as being used to perform splitting, corrupting and recombining operations, it should be understood that different LLMs may be used to perform different ones of such tasks or the tasks could be implemented using other neural network models or other text processing techniques. The use of the example single LLM is therefore not intended to be limiting.

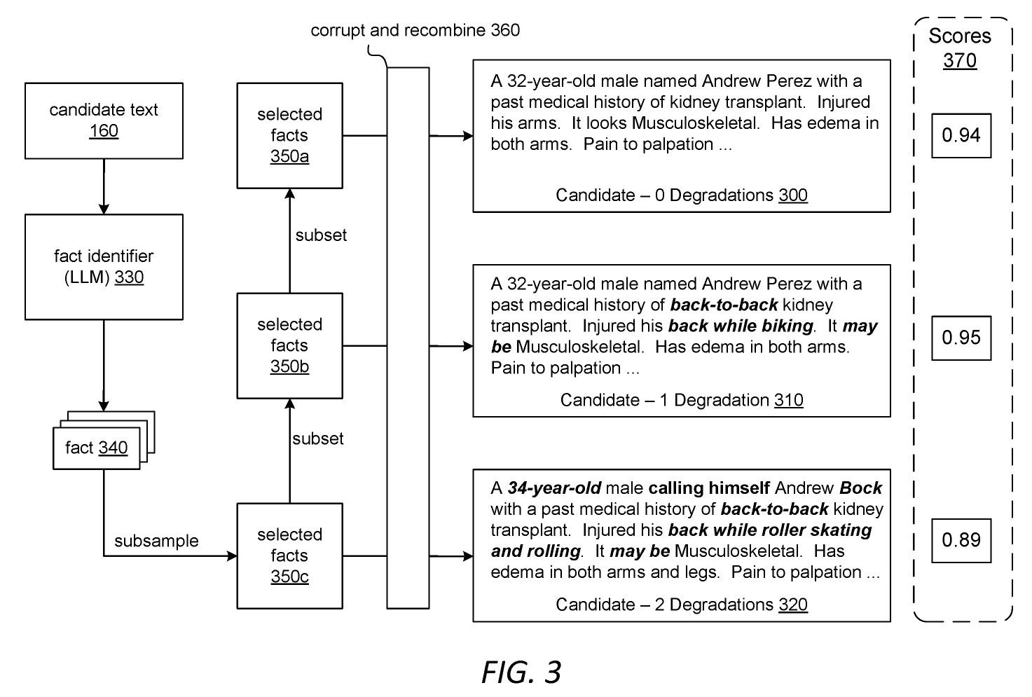

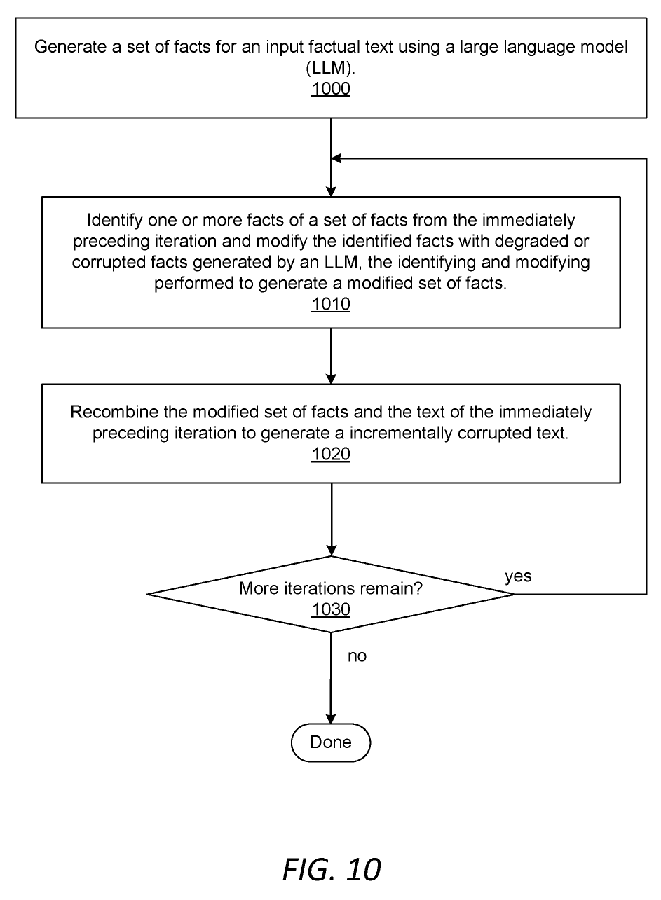

FIG. 3 illustrates a degradation process for a degradation-based method to verify performance of evaluation metrics, according to some embodiments. In at least one embodiment, a candidate text 160 may be received at a perturbation function, such as perturbator 145 of FIG. 1 and perturbation function defined in lines 1 – 13 of FIG. 2, the candidate text to be degraded for a number of iterations, shown for simplicity as three iterations in FIG. 3. It should be understood that any number of iterations may be employed and the example number is not intended to be limiting. Then, as shown in 330, a fact identifier may be employed to generate a set of facts 340, such as shown in lines 6 and 15 – 17 of FIG. 2 and discussed in further detail below in FIG. 10. Then, in at least one embodiment an number iterations are performed to generate subsets of selected facts that, when modified, increasingly degrade the candidate text 160 over a series of candidate texts 300, 310 and 320. These selected facts 350a, 350b and 350c are then corrupted and recombined 360 such as shown in lines 7 and 8 of FIG. 2 and discussed in further detail below in FIG. 10. Then the increasingly degraded candidate texts 300, 310 and 320 may be evaluated but a target evaluator such as target evaluator 120 to generate metrics such as scores 370. In at least one embodiment, these metrics may be determined by examining two key properties: monotonicity and discrimination power. Regarding monotonicity, a good evaluation metric may assign scores that decrease as the candidate text is increasingly degraded. Mathematically, for an evaluation metric Ei:

Ei(R, C) > Ei(R, C1) > ... > Ei(R, Cn)

Regarding Discrimination Power, a good evaluation metric may discriminate between candidates with differing quality. If two evaluation metrics E1 and E2 are used to score the candidates, E1 is deemed to have higher discrimination power if the differences between its scores are larger than those of E2.

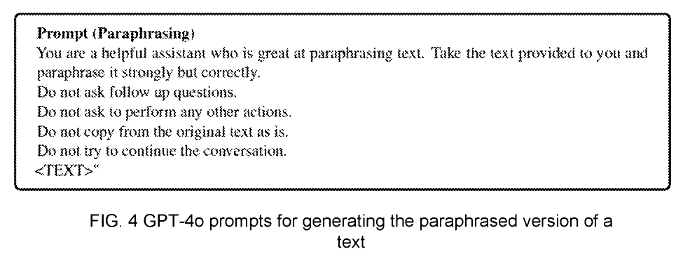

FIGS. 4 – 7 illustrates various prompts suitable for use with large language models (LLMs) to perform various tasks of a degradation-based method to verify performance of evaluation metrics, according to some embodiments. FIG. 4 illustrates a prompt for generating paraphrased versions of texts, according to some embodiments. FIG. 5 illustrates a prompt for generating a series of atomic facts of texts, according to some embodiments. FIG. 6 illustrates a prompt for corrupting a one or more facts, according to some embodiments. FIG. 7 illustrates a prompt for recombining altered facts into a coherent text, according to some embodiments. While these example prompts are provided in a particular natural language, those of ordinary skill in the art will understand that LLMs may be trained to recognize and operate with multiple natural languages and/or other languages and the particular natural language of the example prompts are merely one example where any number of languages may be envisions. This particular natural language is thus not intended to be limiting.

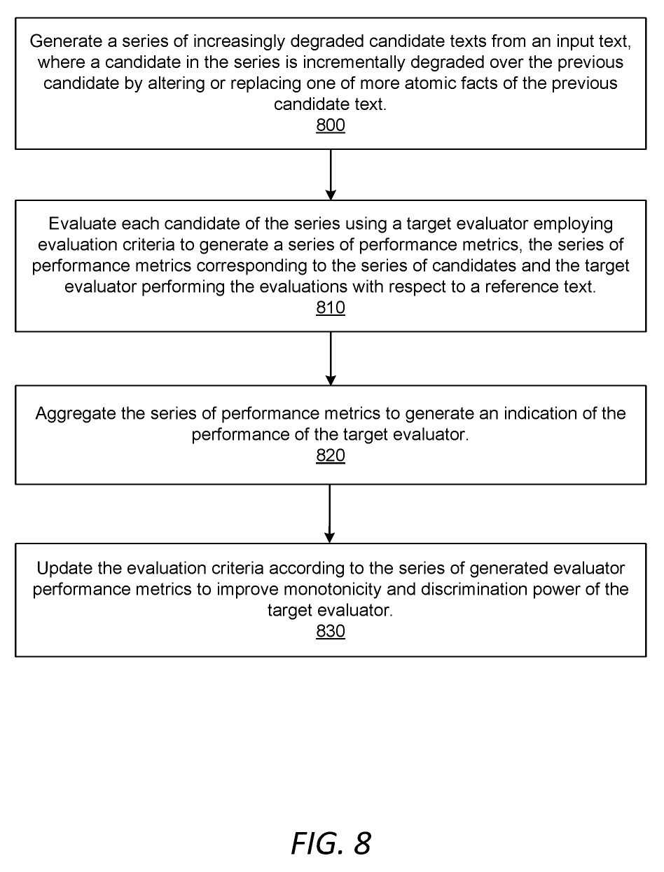

FIG. 8 is a flowchart illustrating a degradation-based method to verify and improve performance of evaluation metrics and/or a target evaluator, according to some embodiments. The process begins at 800 where, in at least one embodiment, a series of increasingly degraded candidate texts, such as texts 300, 310 and 320 of FIG. 3, may be generated from an input text such as candidate text 160 of FIG. 1. Each of the generated candidate texts may be incrementally degraded over a previous candidate by altering or replacing one or more atomic facts of the previous candidate text, in at least one embodiment.

Then, as shown in 810, in at least one embodiment each candidate text of the series of candidate texts may be evaluated using a target evaluator, such as target evaluator 120 of FIG. 1, to generate a series of performance metrics, where individual performance metrics of the series correspond to individual candidate texts of the candidate text series. The target evaluator may, in at least one embodiment, perform evaluations according to evaluation criteria, such as criteria 122 of FIG. 1, and with respect to a reference text, such as gold standard 150 of FIG. 1, that includes ground truths, i.e. verified, objective and accurate data or facts obtained through direct observation or measurement.

Then, as shown in 820, in at least one embodiment the target evaluator may be evaluated according to the series of generated performance metrics to generate an aggregate performance indicator of the target evaluator. In at least one embodiment, two properties may be considered: monotonicity and discrimination power. Regarding monotonicity, a good evaluation metric may assign scores that decrease as the candidate text is increasingly degraded. Mathematically, for an evaluation metric Ei:

Ei(R, C) > Ei(R, C1) > ... > Ei(R, Cn)

Regarding Discrimination Power, a good evaluation metric may discriminate between candidates with differing quality. If two evaluation metrics E1 and E2 are used to score the candidates, E1 is deemed to have higher discrimination power if the differences between its scores are larger than those of E2. In addition, as shown in 830, in at least one embodiment evaluation criteria of the target evaluator, such as criteria 122 of FIG. 1, may be updated according to the series of generated performance metrics and/or the aggregate performance indicator to improve monotonicity and discrimination power of the target evaluator.

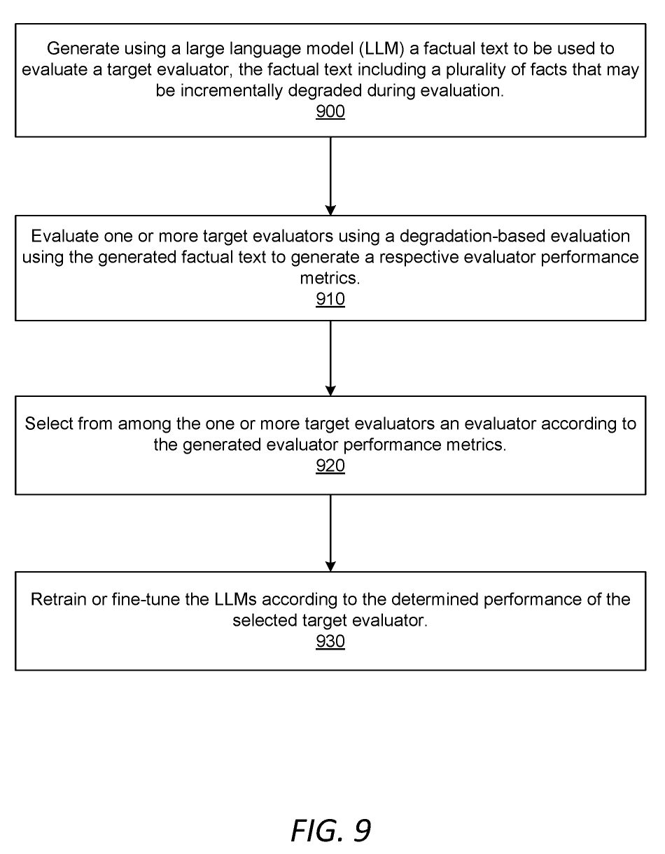

FIG. 9 is a flowchart illustrating a degradation-based method to select and improve an evaluator, according to some embodiments. The process begins at 900 where, in at least one embodiment, an LLM may be used to generate a factual text, such as candidate text 160 of FIG. 1. The factual text may be used to evaluate one or more target evaluators, such as target evaluator 120 of FIG. 1, and may include a plurality of facts that may be incrementally or progressively degraded during evaluation, in at least one embodiment.

Then, as shown in 910, in at least one embodiment one or more target evaluators, such as target evaluator 120 of FIG. 1, may be evaluated using a degradation-based evaluator, such as evaluator verifier 100 of FIG. 1, using the generated factual text. This evaluation may generate respective evaluator performance metrics. In at least one embodiment, the performance metrics may include monotonicity and/or discrimination power. Regarding monotonicity, a good evaluation metric may assign scores that decrease as the candidate text is increasingly degraded. Mathematically, for an evaluation metric Ei:

Ei(R, C) > Ei(R, C1) > ... > Ei(R, Cn)

Regarding Discrimination Power, a good evaluation metric may discriminate between candidates with differing quality. If two evaluation metrics E1 and E2 are used to score the candidates, E1 is deemed to have higher discrimination power if the differences between its scores are larger than those of E2.

Then, as shown in 920, a target evaluator may be selected or chosen from among the evaluated target evaluators according to the generated evaluator performance metrics. In at least one embodiment, selection may be based on monotonicity and/or discrimination power of respective target evaluators. Additionally, as shown in 930 in at least one embodiment one or more LLMs may be retrained or fine-tuned according to the determined performance of the selected target evaluator.

FIG. 10 is a flowchart illustrating a perturbation mechanism for a degradation-based method to verify performance of evaluation metrics, according to some embodiments. The process begins at 1000 where an input factual text may be split to generate into a set of atomic facts, such as facts 340 of FIG. 3, using an LLM such as fact identifier LLM 330 of FIG. 3. In at least one embodiment, the LLM may be instructed to perform the splitting using a prompt such shown in FIG. 5 above. The process may then execute a number of iterations of progressive degradation of the input factual text as described in steps 1010 and 1020.

As shown in 1010, in at least one embodiment, one or more facts of the set of generated facts from an immediately preceding iteration may be identified and the identified facts replaced or modified using an LLM, where the LLM may be prompted to generate corrupted facts in order to generate a modified set of facts such as by using a prompt as shown in FIG. 6 above. In at least one embodiment, the LLM may be domain-specific: selected, trained and/or fine-tuned to optimize degradation performance for a domain of generated facts including the atomic facts used in the evaluation. In at least one embodiment, an LLM used to modify or degrade selected atomic facts may be a different LLM than used to generate the set of facts for the input factual text, where in other embodiments a same LLM may be used for both. In at least one embodiment, a number of facts to corrupt or degrade may be determined, in at least one embodiment, according to a number of iterations, where individual facts may be selected randomly or in any number of other manners.

Then, as shown in 1020, in at least one embodiment the degraded facts may be recombined with the candidate text using the LLM and a prompt such as shown in FIG. 7 above. If additional iterations remain, as shown in a positive exit from 1030, then the process may return to step 1010. If no additional iterations remain, as shown in a negative exit from 1030, then the process is complete. Although a single LLM described in FIG. 10 as being used to perform splitting, corrupting and recombining operations, it should be understood that different LLMs may be used to perform different ones of such tasks or the tasks could be implemented using other neural network models or other text processing techniques. The use of the example single LLM is therefore not intended to be limiting.

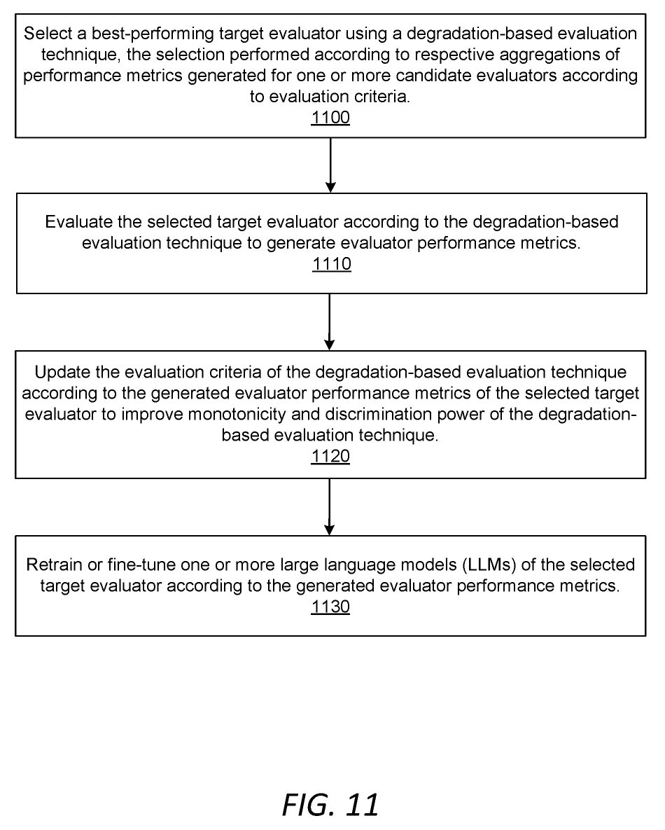

FIG. 11 is a flowchart illustrating selecting and improving performance of a target evaluator using a degradation-based method to verify performance of evaluation metrics, according to some embodiments. In at least one embodiment, a degradation-based method to verify performance of evaluation metrics may be used to select and improve various aspects of performance of target evaluators, such as target evaluator 120 of FIG. 1. The process begins at 1100 where a best performing target evaluator may be selected using a degradation-based evaluation technique such as discussed above in FIG. 9. In at least one embodiment, selection may be performed according to respective aggregations of performance metrics generated for one or more candidate evaluators according to evaluator-specific criteria. In at least one embodiment, selection may be based on monotonicity and/or discrimination power of respective target evaluators. In at least one embodiment, evaluation of particular candidate evaluators may include identifying and implementing improvements in the evaluator-specific criteria of a particular candidate evaluator such as disclosed in step 830 of FIG. 8 above.

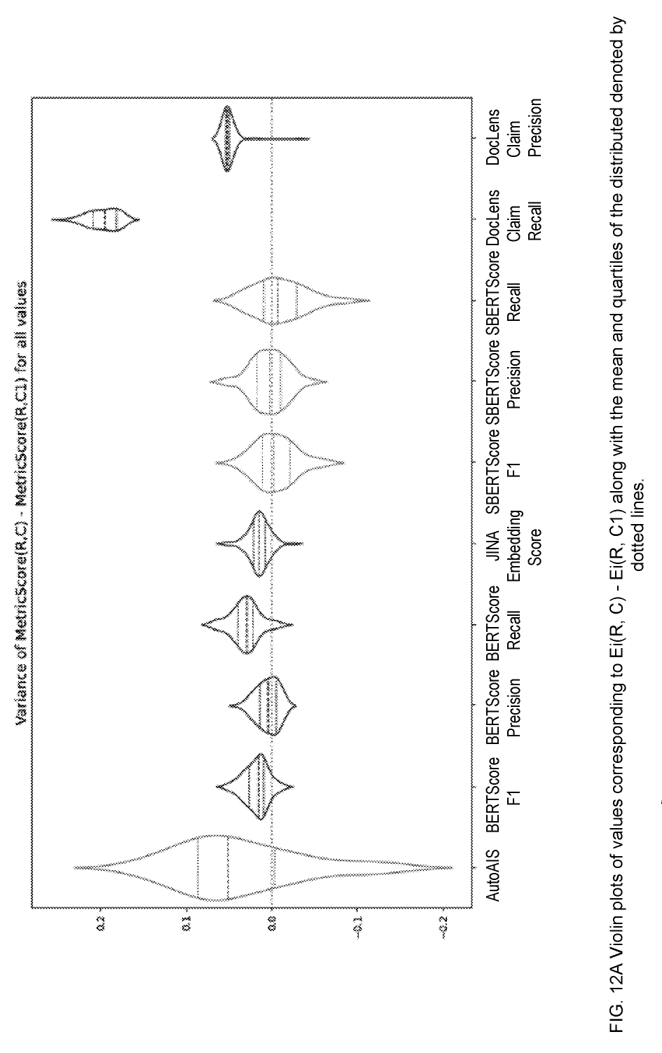

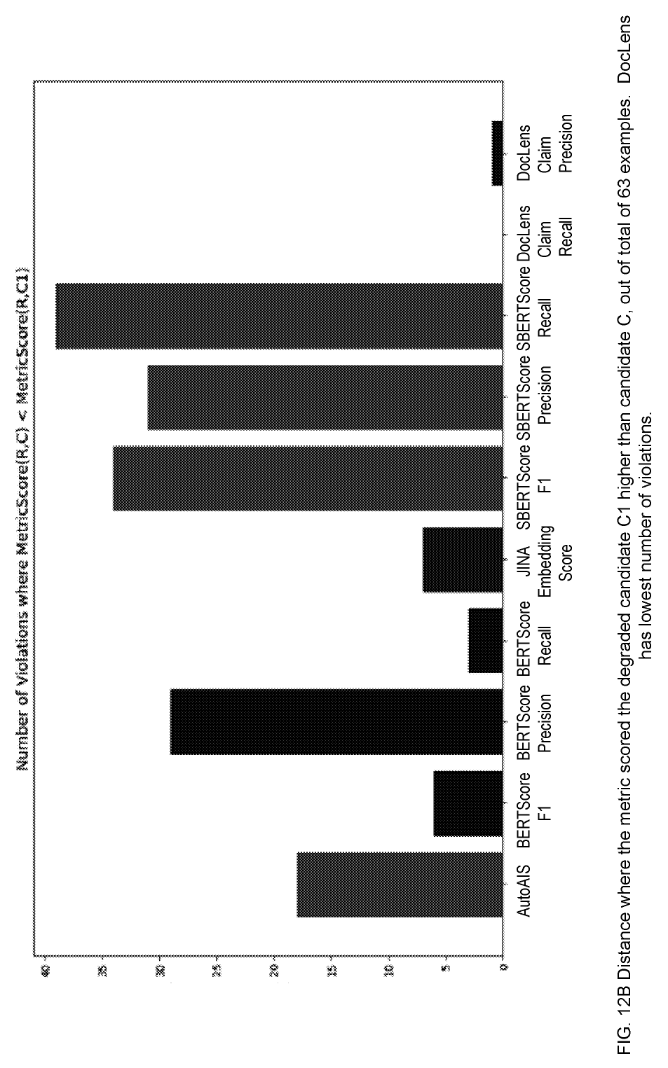

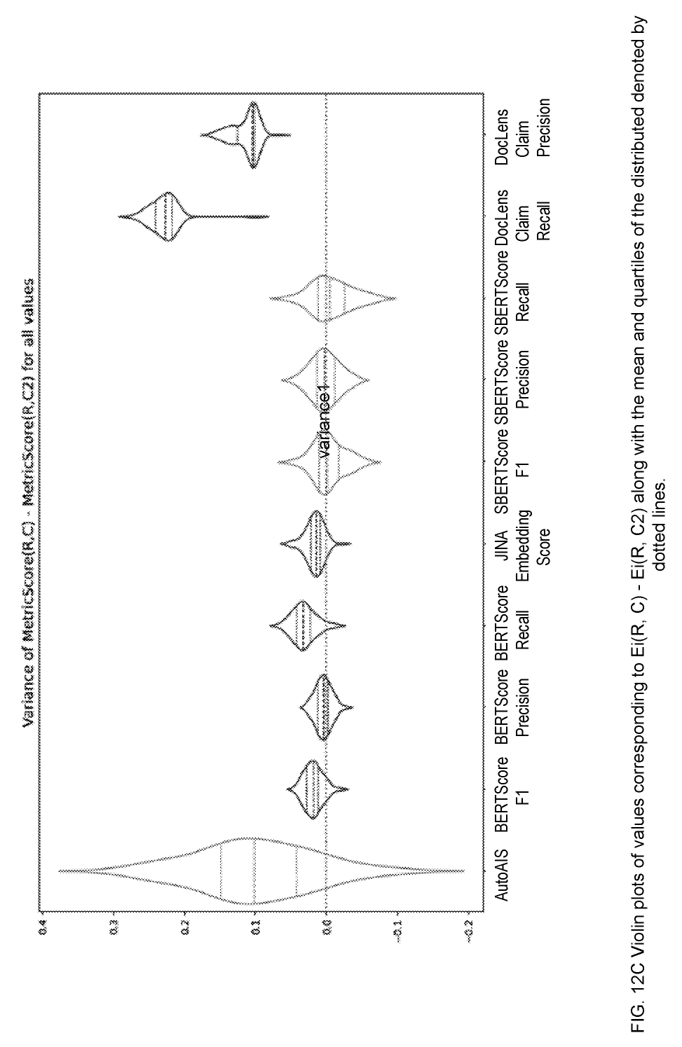

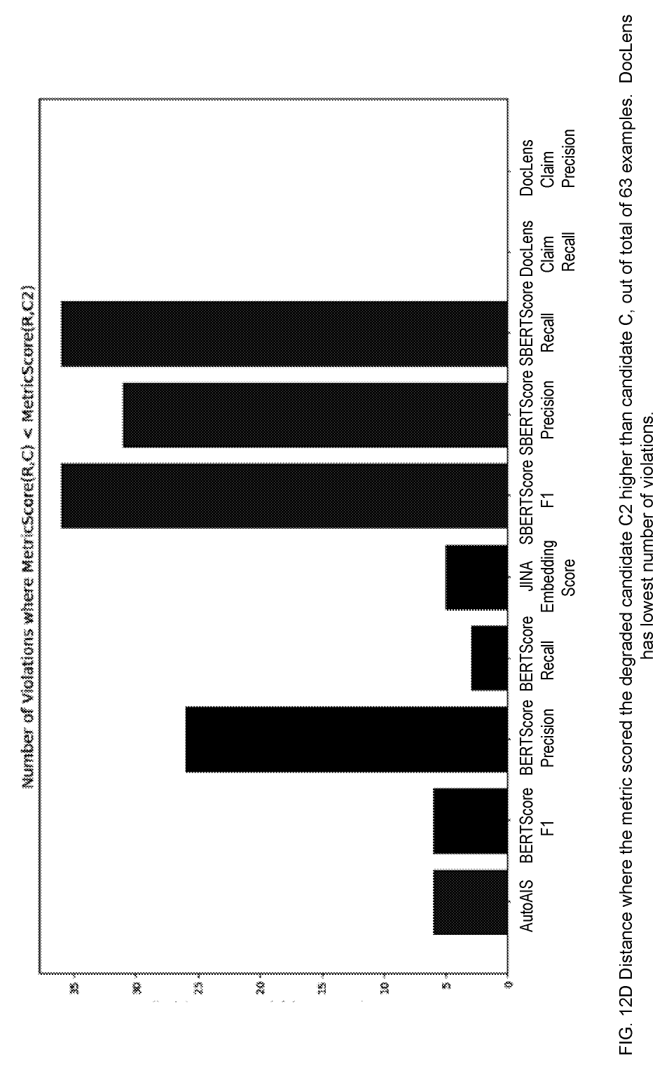

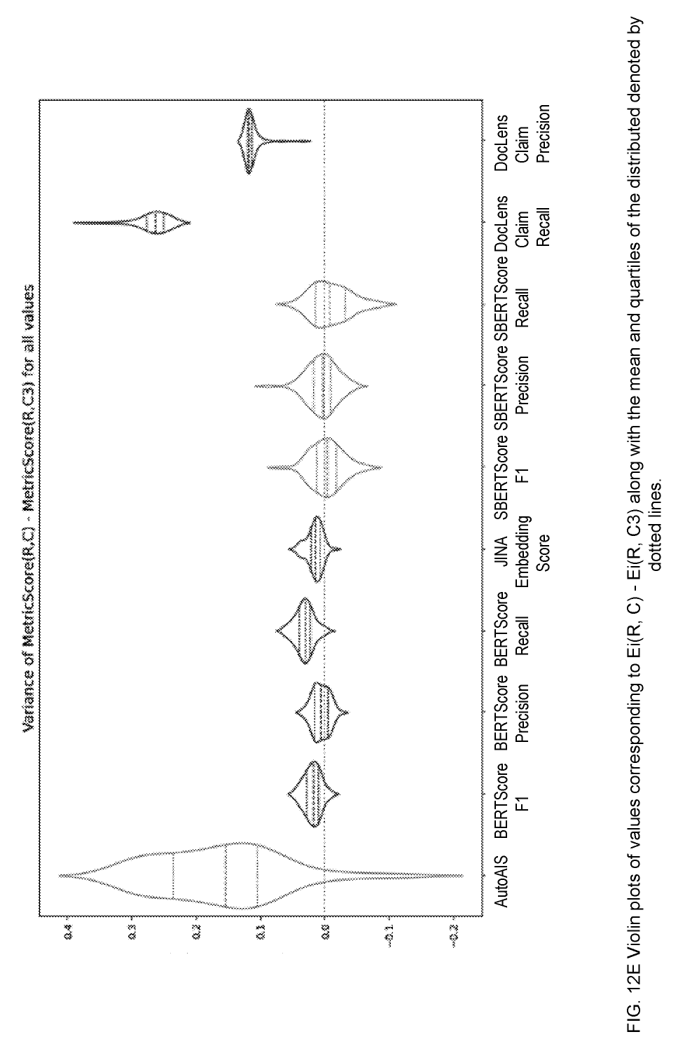

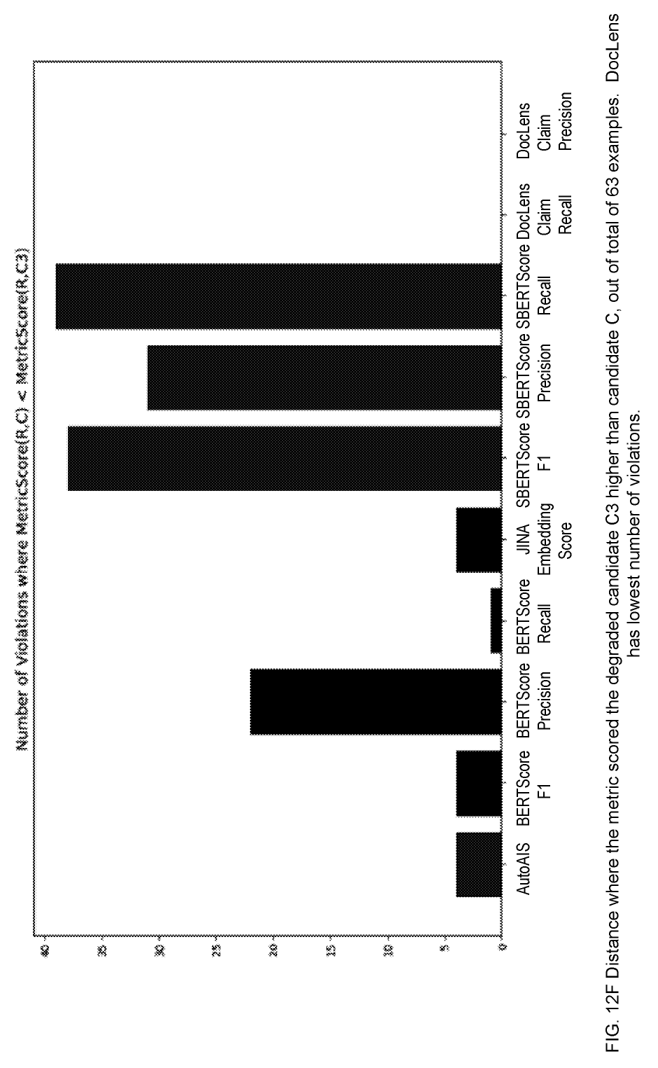

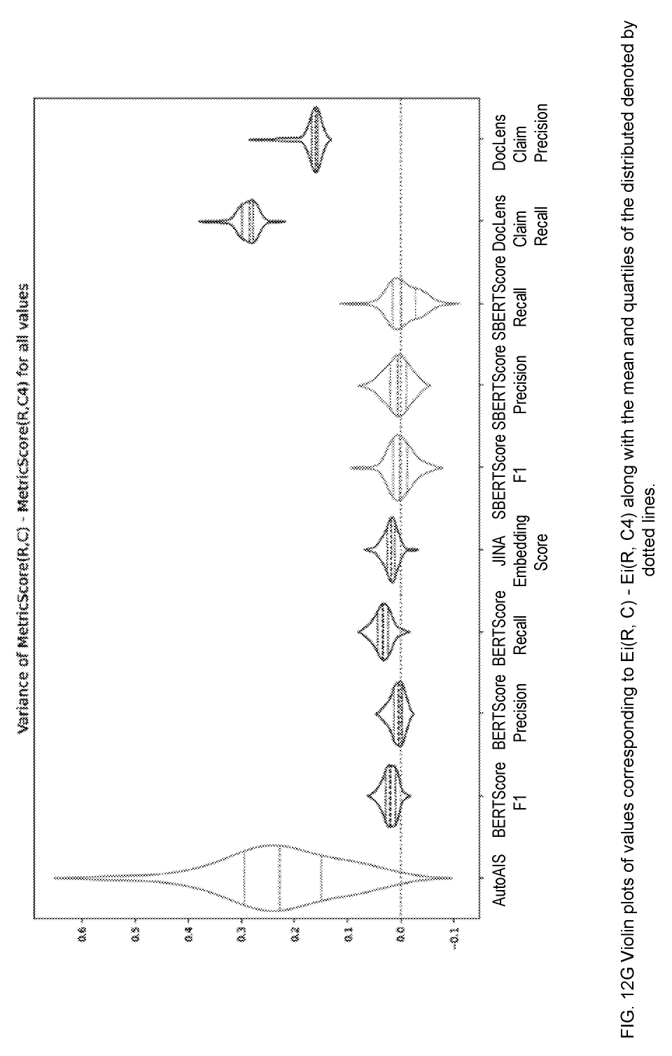

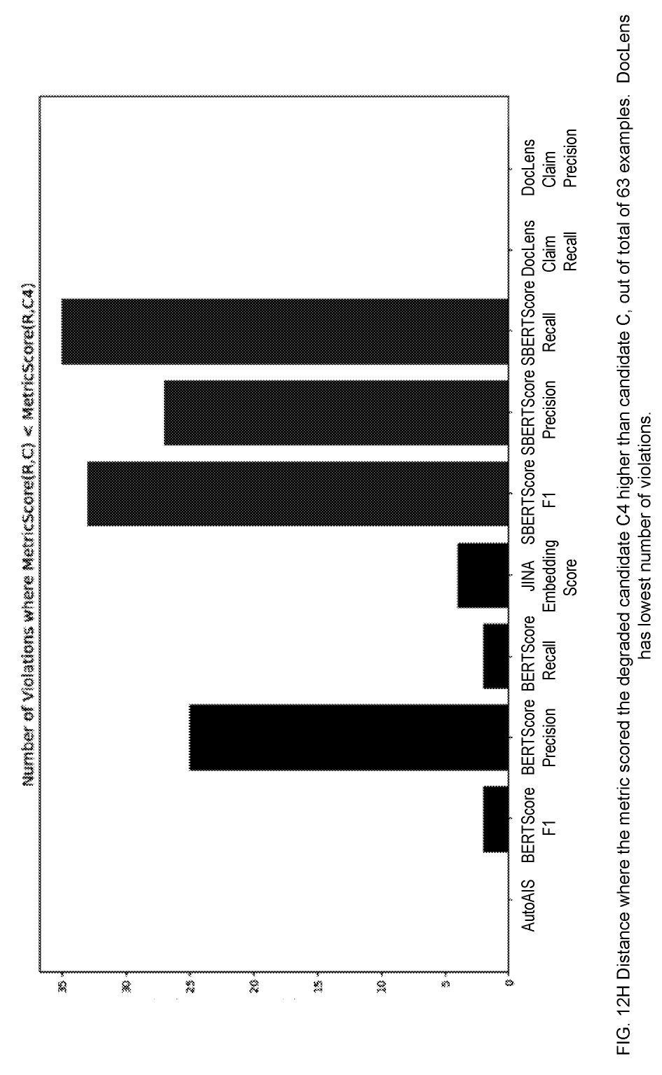

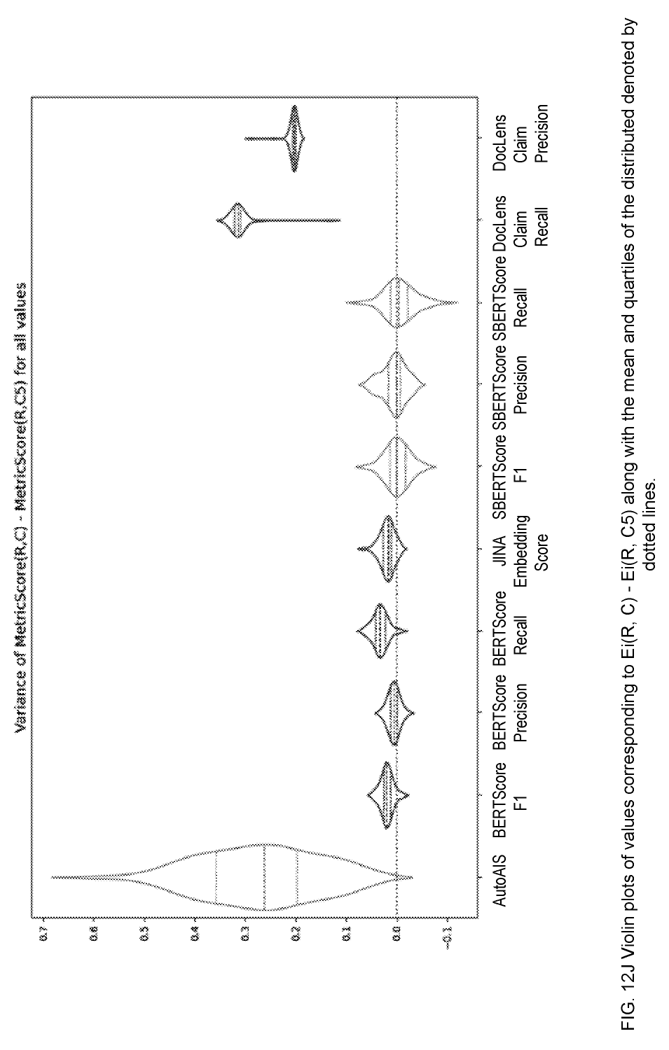

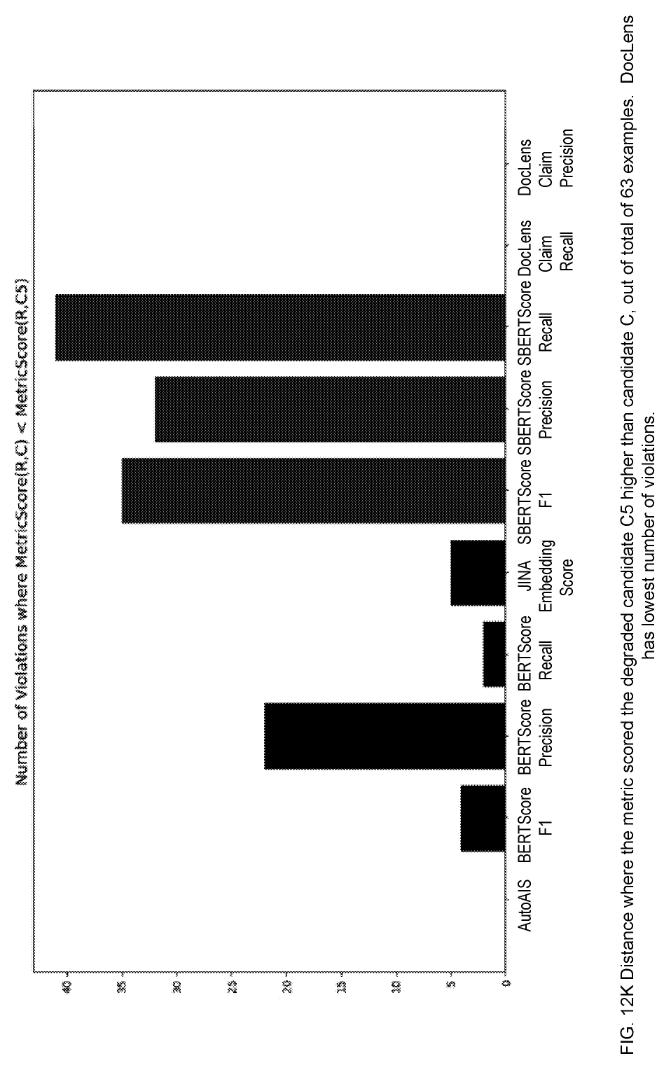

Then, as shown in 1110, in at least one embodiment a selected target evaluator may be evaluated using a degradation-based technique, such as disclosed in FIGS. 8 and 10, to generate performance metrics, including an aggregate performance metric, for the selected target evaluator. In at least one embodiment, as shown in 1120, evaluation criteria for the selected evaluator may be updated according to generated evaluator performance metrics, including an aggregate performance metric, to improve monotonicity and discrimination power of the selected evaluator. Furthermore, in at least one embodiment, one or more LLMs, such as LLM 146 of FIG. 1, used to identify, select, degrade and recombine facts of an input factual text such as disclosed in steps 1010 and 1020 of FIG. 10, may be retrained or fine-tuned according to the generated performance metrics for the selected target evaluator to improve monotonicity and discrimination power of the selected evaluator. In various embodiments, using a combination of improvements of performance criteria in identifying performance of individual degraded candidate texts of a series of increasingly degraded texts, identifying performance in aggregate of of various target evaluators, training and fine-tuning of LLMs used by various target evaluators as part of a perturbation mechanism for a degradation-based method of evaluation, and selection of highest performing target evaluators, a highest performing evaluation method of generation of factual texts, such as shown below in FIGS. 12A – 12K, may be achieved.

FIGS. 12A – 12K show experimental results of evaluation of a number of well known target evaluators. An ACI-Bench dataset, a medical dataset containing SOAP notes, is used to evaluate the degradation-based evaluator. Here, a SOAP note is a structured document used by healthcare professionals to record patient information, comprising Subjective, Objective, Assessment, and Plan components. For each patient case, ACI-Bench provides a gold reference SOAP note that includes verified, objective and accurate data or facts obtained through direct observation or measurement. In the experimental results, violations occur, and are quantified, when a metric score does not decrease for increasingly degraded input texts, thus indicating a failure of monotonicity and discrimination power. The following target evaluators are evaluated using the techniques disclosed above in FIGS. 2 – 11:

### AutoAIS

AutoAIS is an automatic evaluation metric that focuses on assessing the factual accuracy and consistency of generated text. It uses a combination of information retrieval and natural language inference techniques to compare the generated text with a knowledge source or reference text. AutoAIS aims to provide a more reliable and interpretable evaluation of factuality than traditional metrics.

### BERTScore

A BERTScore leverages contextual embeddings from BERT to assess the similarity between a candidate sentence and a reference sentence. It computes a fine-grained similarity score for each token in the candidate sentence with each token in the reference sentence, using contextual embeddings. These scores are then aggregated to produce an overall similarity score.

### BLEURT

BLEURT is a learned evaluation metric that is trained to predict human quality judgments. It is designed to be robust and generalize well across different domains and tasks. BLEURT uses a large pre-trained language model and is fine-tuned on a dataset of human ratings, allowing it to capture subtle aspects of text quality that are often missed by other metrics.

### SBERTScore

SBERTScore is a modification of BERTScore that calculates sentence-level embeddings using Sentence-BERT (SBERT). While BERTScore computes token-level similarities, SBERTScore computes the embedding for an entire sentence and compares those embeddings. This change aims to capture the overall semantic similarity between sentences more effectively, potentially improving the correlation with human judgments, particularly for longer texts where sentence-level coherence is important.

### JINA Similarity Embeddings

JINA Similarity Embeddings provide a method for generating dense vector representations of text that are optimized for similarity search and comparison. These embeddings can be used for various natural language processing tasks, including text evaluation. By comparing the embeddings of generated and reference texts, one can assess their semantic similarity. JINA embeddings are designed to be efficient and scalable, making them suitable for large-scale evaluation tasks.

### DocLens

DocLens is an evaluation framework designed to assess the quality of text generation tasks in the medical domain. The framework calculates the conciseness, and completeness of the generated text for clinical note generation. The metrics can be computed by various types of evaluators including instruction-following (both proprietary and open-source) and supervised entailment models. While multiple models can be executed with this framework, GPT4-o is widely used, so we replicate the same setting.

To verify the quality of the synthetic generations, 2 human annotators were provided 50 sets of (R, C, C1) generated from the Natural Questions dataset. The task required the annotators to determine if candidate C was factually more accurate than C1 with respect to the reference R, the annotators had an interrogator agreement of 0.98.

FIGS. 12A and 12B illustrates variance of metrics and number of violations for a first candidate perturbation and various target evaluators, according to some embodiments. FIG. 12A shows violin plots of variance of metric scores for a first candidate perturbation and various target evaluators, where a violin plot depicts distributions of numeric data for one or more groups using density curves. The width of each curve corresponds with the approximate frequency of data points in each region. FIG. 12B shows a number of violations, or negative variances of metric scores for a first candidate perturbation and various target evaluators.

FIGS. 12C and 12D illustrates variance of metrics and number of violations for a second candidate perturbation and various target evaluators, according to some embodiments. FIG. 12C shows violin plots of variance of metric scores for a second candidate perturbation and various target evaluators, where a violin plot depicts distributions of numeric data for one or more groups using density curves. The width of each curve corresponds with the approximate frequency of data points in each region. FIG. 12D shows a number of violations, or negative variances of metric scores for a second candidate perturbation and various target evaluators.

FIGS. 12E and 12F illustrates variance of metrics and number of violations for a third candidate perturbation and various target evaluators, according to some embodiments. FIG. 12E shows violin plots of variance of metric scores for a third candidate perturbation and various target evaluators, where a violin plot depicts distributions of numeric data for one or more groups using density curves. The width of each curve corresponds with the approximate frequency of data points in each region. FIG. 12F shows a number of violations, or negative variances of metric scores for a third candidate perturbation and various target evaluators.

FIGS. 12F and 12G illustrates variance of metrics and number of violations for a fourth candidate perturbation and various target evaluators, according to some embodiments. FIG. 12G shows violin plots of variance of metric scores for a fourth candidate perturbation and various target evaluators, where a violin plot depicts distributions of numeric data for one or more groups using density curves. The width of each curve corresponds with the approximate frequency of data points in each region. FIG. 12H shows a number of violations, or negative variances of metric scores for a fourth candidate perturbation and various target evaluators.

FIGS. 12J and 12K illustrates variance of metrics and number of violations for a fifth candidate perturbation and various target evaluators, according to some embodiments. FIG. 12J shows violin plots of variance of metric scores for a fifth candidate perturbation and various target evaluators, where a violin plot depicts distributions of numeric data for one or more groups using density curves. The width of each curve corresponds with the approximate frequency of data points in each region. FIG. 12K shows a number of violations, or negative variances of metric scores for a fifth candidate perturbation and various target evaluators.

The mechanisms for implementing subject level privacy attack analysis for federated learning, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

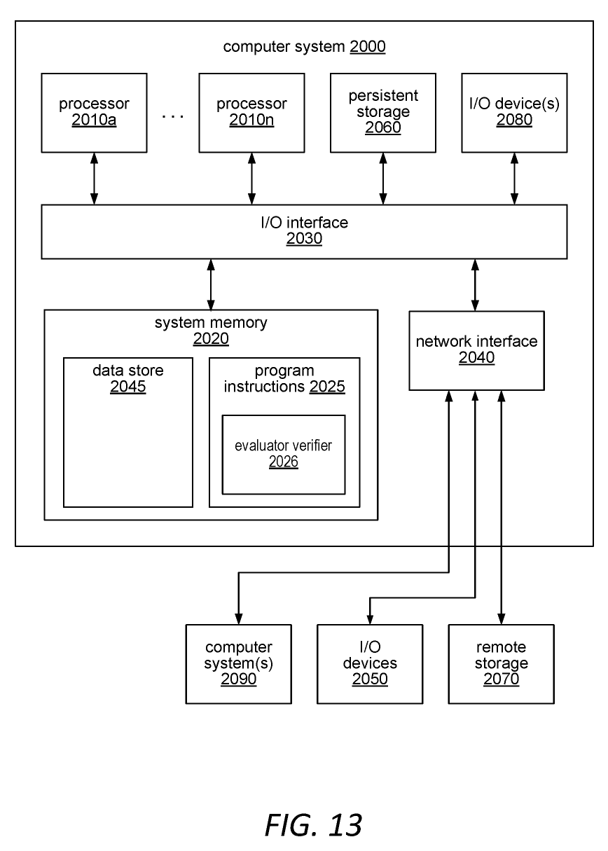

FIG. 13 illustrates a computing system configured to implement the methods and techniques described herein, according to various embodiments. The computer system 2000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device. Any of various computer systems may be configured to implement processes associated with a technique for multi-region, multi-primary data store replication as discussed with regard to the various figures above. FIG. 13 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 13 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for implementing an evaluator verifier as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 16 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, SolarisTM, MacOSTM, WindowsTM, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service’s interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

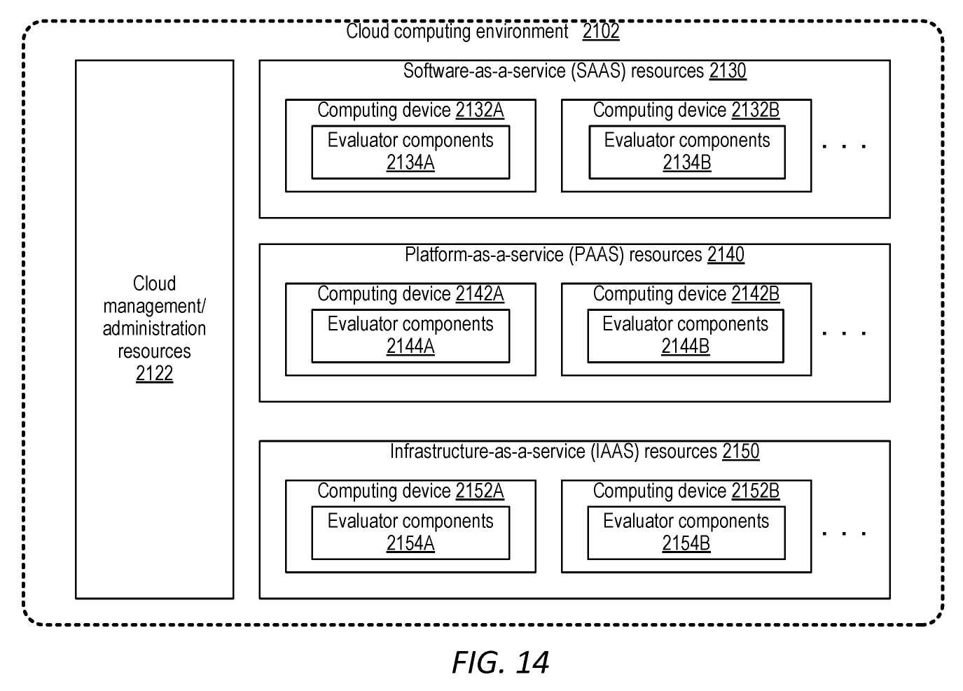

FIG. 14 illustrates an example cloud computing environment whose resources may be employed to implement degradation-based evaluation, according to at least some embodiments. As shown, cloud computing environment 2102 may include cloud management/administration resources 2122, software-as-a-service (SAAS) resources 2130, platform-as-a-service (PAAS) resources 2140 and/or infrastructure-as-a-service (IAAS) resources 2150. Individual ones of these subcomponents of the cloud computing environment 2102 may include a plurality of computing devices (e.g., devices similar to device 2000 shown in FIG. 13) distributed among one or more data centers in the depicted embodiment, such as devices 2132A, 2132B, 2142A, 2142B, 2152A, 2152B and the like. A number of different types of network-accessible services, such as data storage service, database services, virtual computing services, machine learning services and the like may be implemented using the resources of the cloud computing environment in various embodiments.

In the depicted embodiment, clients or customers of the cloud computing environment 2102 may choose the mode in which they wish to utilize one or more of the network-accessible services offered. For example, in the IAAS mode, in some embodiments the cloud computing environment may manage virtualization, servers, storage and networking on behalf of the clients, but the clients may have to manage operating systems, middleware, data, runtimes, and applications. If, for example, a client wishes to use IAAS resources 2150 for degradation-based evaluation, the clients may identify one or more virtual machines implemented using computing devices 2152 (e.g., 2152A or 2152B) as the platforms on which the evaluator components 2154 (e.g., 2154A, 2154B, etc.) are to be run, download the tools, and issue commands to perform document search via programmatic interfaces provided by the cloud computing environment.

In the PAAS mode, clients may be responsible for managing a smaller subset of the software/hardware stack in various embodiments: e.g., while the clients may still be responsible for application and data management, the cloud environment may manage virtualization, servers, storage, network, operating systems as well as middleware, evaluator components 2144 (e.g., 2144A, 2144B, etc.) may be deployed to, and run at, PAAS resources (e.g., 2142A, 2142B etc.) as applications managed by various clients in different embodiments.

In the SAAS mode, the cloud computing environment may offer degradation-based evaluation as a pre-packaged service, managing even more of the software/hardware stack in various embodiments – e.g., clients may not even have to explicitly manage applications or data. Instead, for example, with respect to search functionality of the kind discussed above, clients may simply submit (e.g., via programmatic interfaces) creation requests and the SAAS resources may utilize evaluator components 2134 (e.g., 2134A, 2134B, etc.) pre-installed on computing devices 2132 (e.g., 2132A, 2143B etc.) to generate, store, and execute document search functions as desired.

The administration resources 2122 may perform resource management-related operations (such as provisioning, network connectivity, ensuring fault tolerance and high availability, and the like) for all the different modes of cloud computing that may be supported in various embodiments. Clients may interact with various portions of the cloud computing environment using a variety of programmatic interfaces in different embodiments, such as a set of APIs (application programming interfaces), web-based consoles, command-line tools, graphical user interfaces and the like. Note that other modes of providing services (including topic modeling services) may be supported in at least some embodiments, such as hybrid public-private clouds and the like.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

Those skilled in the art will appreciate that computer system 2000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 2000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2000 may be transmitted to another computer system via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
at least one processor;
a memory, comprising program instructions that when executed by the at least one processor cause the at least one processor to implement a degradation-based evaluator configured to evaluate a target evaluator, wherein to evaluate the target evaluator the degradation-based evaluator is configured to:
iteratively degrade a candidate text to generate a series of increasingly degraded candidate texts;
evaluate, by the target evaluator with respect to a reference text, the series of increasingly degraded candidate texts to generate a series of performance metrics; and
evaluate the series of performance metrics to evaluate the performance of the target evaluator.

2. The system of claim 1, wherein the evaluation of the series of increasingly degraded candidate texts is performed according to one or more evaluation criteria, and wherein the degradation-based evaluator is further configured to revise the one or more evaluation criteria according to the evaluating of the performance of the target evaluator.

3. The system of claim 1, wherein to iteratively degrade the candidate text the degradation-based evaluator is configured to:
identify a plurality of facts in the candidate text; and
execute a plurality of iterations to generate the series of increasingly degraded candidate texts, wherein to execute an iteration of the plurality of iterations the degradation-based evaluator is configured to replace one or more of the plurality of facts of a generated text of a previous iteration with one more corrupted facts to generate a text of a current iteration.

4. The system of claim 3, wherein the identification of the plurality of facts in the candidate text is performed using a large language model.

5. The system of claim 1, wherein the candidate text is generated by a large language model, and wherein the memory comprises additional program instructions that when executed by the at least one processor cause the at least one processor to initiate, responsive to evaluating the performance of the target evaluator, retraining or fine-tuning of the large language model.

6. The system of claim 1, wherein the degradation-based evaluator is further configured to:
evaluate a plurality of different target evaluators including the target evaluator; and
identify a highest performing target evaluator from the plurality of different target evaluators according to the respective performance evaluations of the plurality of different target evaluators.

7. The system of claim 6, wherein to evaluate the performance of the target evaluator, the degradation-based evaluator is configured to determine a discrimination metric for the target evaluator, the discrimination metric quantifying discrimination among the series of increasingly degraded candidate texts; and wherein the highest performing target evaluator is identified according to the respective discrimination metrics of the plurality of different target evaluators.

8. A computer-implemented method of evaluate a target evaluator, comprising:
iteratively degrading a candidate text to generate a series of candidate texts including the candidate text and a plurality of increasingly degraded candidate texts;
evaluating, by the target evaluator, the series of candidate texts with respect to a reference text to generate a series of performance metrics; and
evaluating the series of performance metrics to evaluate the performance of the target evaluator.

9. The computer-implemented method of claim 8, wherein the evaluating of the series of increasingly degraded candidate texts is performed according to one or more evaluation criteria, and wherein the method further comprises revising the one or more evaluation criteria according to the evaluating of the performance of the target evaluator.

10. The computer-implemented method of claim 8, wherein iteratively degrading the candidate text comprises:
identifying a plurality of facts in the candidate text; and
executing a plurality of iterations to generate the series of increasingly degraded candidate texts, comprising replacing one or more of the plurality of facts of a generated text of a previous iteration with one more corrupted facts to generate a text of a current iteration.

11. The computer-implemented method of claim 10, wherein the identifying of the plurality of facts in the candidate text is performed using a large language model.

12. The computer-implemented method of claim 8, wherein the candidate text is generated by a large language model, and wherein the method further comprises initiating, responsive to evaluating the performance of the target evaluator, retraining or fine-tuning of the large language model.

13. The computer-implemented method of claim 8, further comprising:
evaluating a plurality of different target evaluators including the target evaluator; and
identifying a highest performing target evaluator from the plurality of different target evaluators according to the respective performance evaluations of the plurality of different target evaluators.

14. The computer-implemented method of claim 13, wherein evaluating the performance of the target evaluator comprises determining a discrimination metric for the target evaluator, the discrimination metric quantifying discrimination among the series of increasingly degraded candidate texts; and wherein the highest performing target evaluator is identified according to the respective discrimination metrics of the plurality of different target evaluators.

15. One or more non-transitory, computer-readable storage media, storing program instructions that when executed on or across one or more computing devices, cause the one or more computing devices to implement a degradation-based evaluator to evaluate a target evaluator, comprising:
iteratively degrading a candidate text to generate a series of increasingly degraded candidate texts;
evaluating, by the target evaluator with respect to a reference text, the series of increasingly degraded candidate texts to generate a series of performance metrics; and
evaluating the series of performance metrics to evaluate the performance of the target evaluator.

16. The one or more non-transitory, computer-readable storage media of claim 15, wherein the evaluating of the series of increasingly degraded candidate texts is performed according to one or more evaluation criteria, and wherein the degradation-based evaluator further performs revising the one or more evaluation criteria according to the evaluating of the performance of the target evaluator.

17. The one or more non-transitory, computer-readable storage media of claim 15, wherein iteratively degrading the candidate text comprises:
identifying a plurality of facts in the candidate text; and
executing a plurality of iterations to generate the series of increasingly degraded candidate texts, wherein to execute an iteration of the plurality of iterations the degradation-based evaluator is configured to replace one or more of the plurality of facts of a generated text of a previous iteration with one more corrupted facts to generate a text of a current iteration.

18. The one or more non-transitory, computer-readable storage media of claim 17, wherein the identifying of the plurality of facts in the candidate text is performed using a large language model.

19. The one or more non-transitory, computer-readable storage media of claim 15, wherein the candidate text is generated by a large language model, and wherein the degradation-based evaluator further performs initiating, responsive to evaluating the performance of the target evaluator, retraining or fine-tuning of the large language model.

20. The one or more non-transitory, computer-readable storage media of claim 15, wherein the degradation-based evaluator further performs:
evaluating a plurality of different target evaluators including the target evaluator, comprising determining respective discrimination metrics for individual target evaluators of the plurality of different target evaluators, the respective discrimination metrics quantifying discrimination among the series of increasingly degraded candidate texts; and
identifying a highest performing target evaluator from the plurality of different target evaluators according to the respective discrimination metrics of the plurality of different target evaluators.
